(19) United States
(12) Patent Application Publication
(10) Pub. No.: US 2025/0379667 A1
(43) Pub. Date: Dec. 11, 2025

(54) PAPR AWARE AGC SWITCH-POINTS

(71) Applicant: QUALCOMM Incorporated, San Diego, CA (US)

(72) Inventors: Arjun NADH, Hyderabad (IN); Saranyan NAGARAJAN, Hyderabad (IN); Raveesh JUNEJA, Hyderabad (IN)

(21) Appl. No.: 18/736,412

(22) Filed: Jun. 6, 2024

(51) Int. Cl. H04B 17/318; H04L 27/26

(52) U.S. Cl. CPC H04B 17/318; H04L 27/2614

(57) ABSTRACT

A method for wireless communication at a user equipment (UE) and related apparatus are provided. In the method, the UE measures a peak-to-average power ratio (PAPR) of an input signal. The PAPR includes the ratio of the peak power above a percentile to the average power of the input signal. The UE further processes the input signal based on a gain state (GS) for the input signal. The GS is determined based on the PAPR and the received signal strength indicator (RSSI) measured for the input signal.

### TECHNICAL FIELD

The present disclosure relates generally to communication systems and, more particularly, to wireless communication that includes automatic gain control (AGC).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to measure a peak-to-average power ratio (PAPR) of an input signal, where the PAPR includes a ratio of a peak power above a percentile to the average power of the input signal; and process the input signal based on a gain state (GS) for the input signal. The GS is determined based on the PAPR and the received signal strength indicator (RSSI) measured for the input signal.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to measure a PAPR of an input signal, where the PAPR includes a ratio of a peak power above a percentile to the average power of the input signal; and process the input signal based on a GS for the input signal. The GS is determined based on the PAPR and the RSSI measured for the input signal.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of dynamic range and power backoff for an analog-to-digital converter (ADC).

FIG. 5 is a diagram illustrating example measurements of an input signal in accordance with various aspects of the present disclosure.

FIG. 6 is a call flow diagram illustrating a method of wireless communication in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a network entity in accordance with various aspects of the present disclosure.

FIG. 9 is a diagram illustrating an example of a hardware implementation for an example apparatus and/or UE.

FIG. 10 is a diagram illustrating an example of a hardware implementation for an example network entity.

### DETAILED DESCRIPTION

In wireless communication, when a high-power signal reaches the receiver port, it may saturate the analog-to-digital converter (ADC) of the receiver. This saturation causes the ADC output to become less reliable and may inaccurately represent the original signal, resulting in signal loss. To prevent the saturation of the ADC, receivers may have several gain states (GSs) that may be activated based on the power level of the incoming signal. For example, as the power of an input signal increases beyond a threshold, the receiver may switch to a gain state having a lower gain to avoid ADC saturation. This threshold, which may be referred to as a “switch point” leading to a change between gain states, may be set with a fixed margin or headroom below the ADC's saturation voltage. Example aspects provide methods and apparatus that enable the adaptive determination of ADC headroom and one or more switch points for different gain states based on the actual peak-to-average power ratio (PAPR) measured on an input signal.

Various aspects relate generally to wireless communication. Some aspects more specifically relate to the PAPR-aware switch points for automatic gain control in wireless communication. In some examples, the UE measures the PAPR of an input signal. The PAPR may include the ratio of a peak power above a percentile to the average power of the input signal. The UE further processes the input signal based on the GS for the input signal. The GS may be determined based on the PAPR and the RSSI measured for the input signal. In some examples, the UE may obtain a set of power estimations of the input signal respectively corresponding to a set of time intervals within a time window; and determine the PAPR based on the set of power estimations of the input signal. In some examples, each power estimation of the set of power estimations may include one or more of a wideband energy estimate (WBEE) or a wideband direct current (DC) estimate (WBDC) of the input signal in the corresponding time interval.

Particular aspects of the subject matter described in this disclosure can be implemented to realize one or more of the following potential advantages. In some examples, by dynamically adjusting the power headroom of the ADC based on actual PAPR measurements rather than a fixed margin, the described techniques enable more efficient use of the ADC's full dynamic range without the risk of saturation, leading to better signal fidelity and less distortion. In some examples, by enabling the ADC to use the most suitable gain state based on the actual PAPR measurements, the described techniques enable real-time adjustments in response to the changes in the signals, thereby allowing the signals to be represented more accurately based on the current signal conditions rather than pre-defined worst-case parameters.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

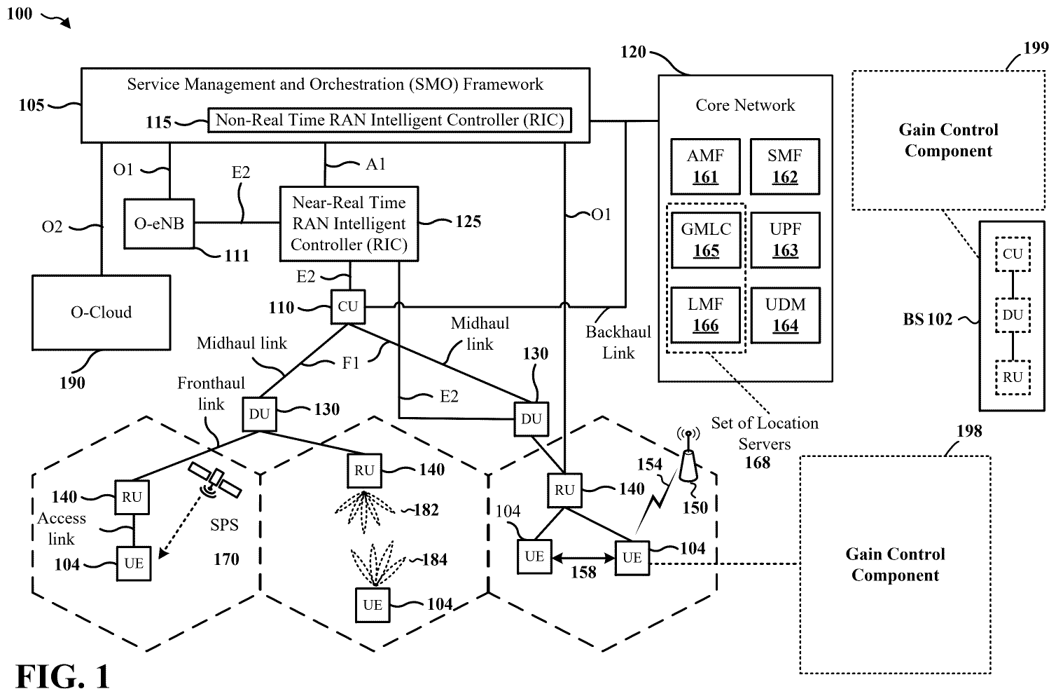

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the gain control component 198. The gain control component 198 may be configured to measure a peak-to-average power ratio (PAPR) of an input signal, where the PAPR includes a ratio of a peak power above a percentile to the average power of the input signal; and process the input signal based on a gain state (GS) for the input signal, where the GS is determined based on the PAPR and the RSSI measured for the input signal. In certain aspects, the base station 102 may include the gain control component 199. The gain control component 199 may be configured to measure a PAPR of an input signal, where the PAPR includes a ratio of a peak power above a percentile to the average power of the input signal; and process the input signal based on a GS for the input signal, where the GS is determined based on the PAPR and the RSSI measured for the input signal. Although the following description may be focused on 5G NR, the concepts described herein may be applicable to other similar areas, such as LTE, LTE-A, CDMA, GSM, and other wireless technologies.

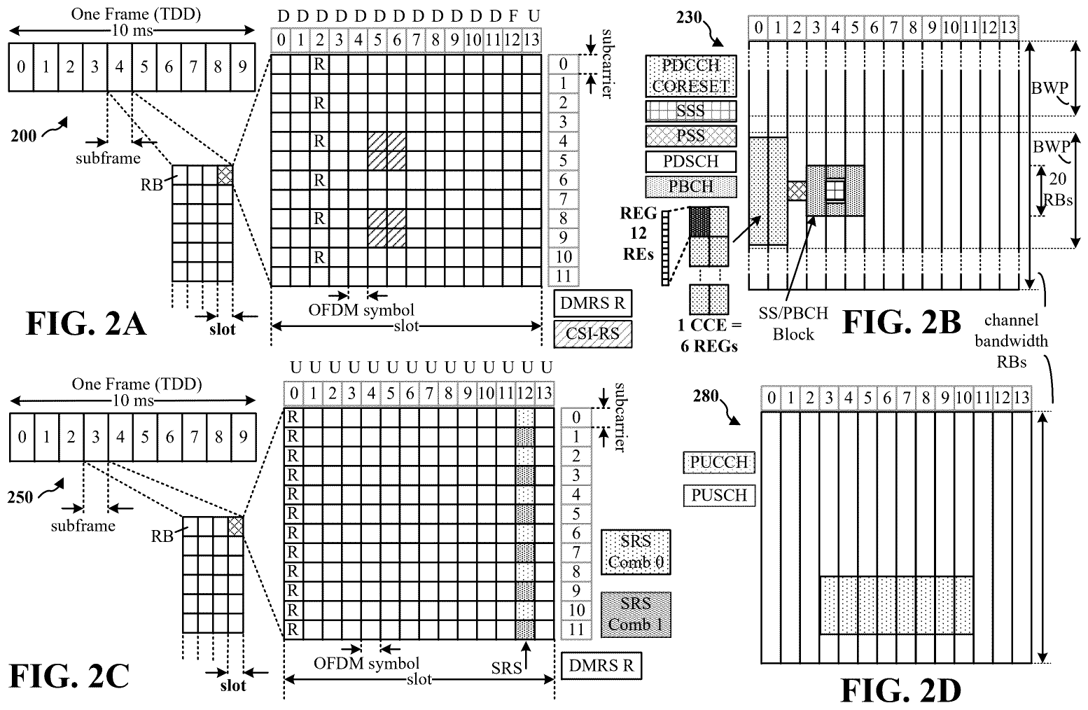

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

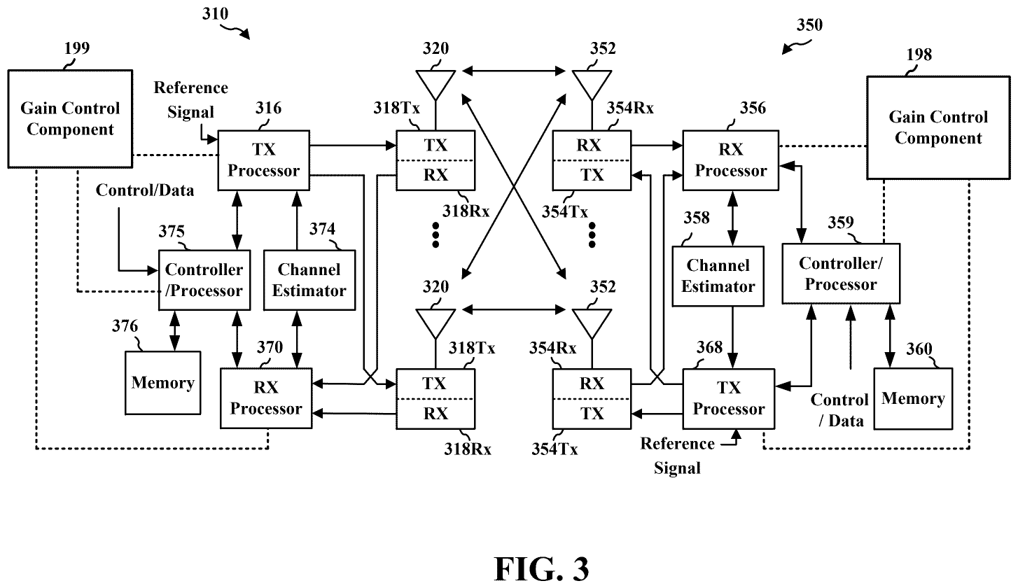

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the gain control component 198 of FIG. 1.

At least one of the TX processor 316, the RX processor 370, and the controller/processor 375 may be configured to perform aspects in connection with the gain control component 199 of FIG. 1.

Example aspects presented herein provide methods and apparatus to compute the PAPR of the signal on the fly, such as during an online call, and drive the receiver automatic gain control loop dynamically based on both the downlink (DL) received signal strength indicator (RSSI) and the PAPR to decide the ADC headroom.

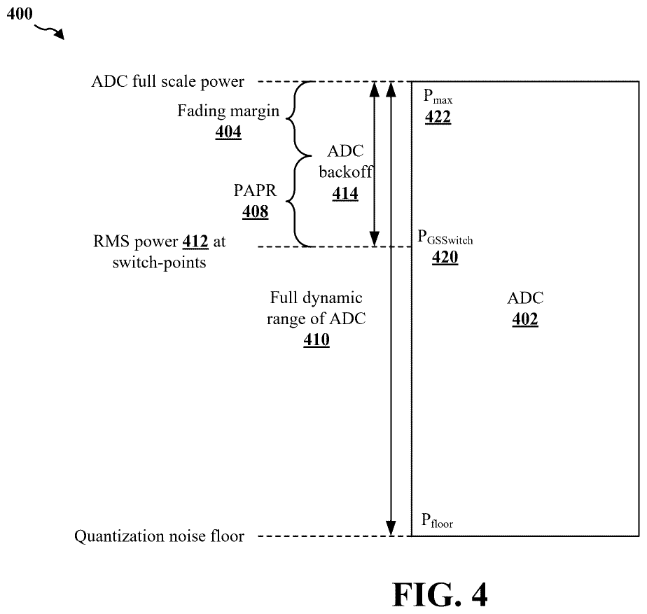

In wireless communication, an analog-to-digital converter (ADC) of a receiver may convert analog signals (e.g., a continuous waveform) received via the communication channel into digital signals that may be further processed by digital systems. FIG. 4 is a diagram 400 illustrating an example of dynamic range and power backoff for an ADC. In some examples, when a high-power signal reaches the receiver port, it may saturate the ADC of the receiver (e.g., ADC 402). This saturation may cause the ADC output to become unreliable and unable to accurately represent the original signal, resulting in signal loss. To prevent the saturation of the ADC, receivers (e.g., the receivers in UE or base stations) may have several gain states (GSs) that may be activated based on the power level of the incoming signal. For example, as the power of an input signal increases beyond a pre-determined threshold, the receiver may switch to a gain state associated with a lower gain to avoid ADC saturation. This threshold, which may be referred to as a “switch point” (e.g., a point at which a switch is made between the use of different gain states) may be set with a fixed margin or headroom below the ADC's saturating voltage or power corresponding to the saturating voltage (e.g., Pₘₐₓ 422), which may also be referred to as a saturation power. For example, the fixed margin may be 18 dBFS, indicating that the gain switch (e.g., P_{GSSwitch} 420) occurs 18 decibels below the full-scale voltage (e.g., Pₘₐₓ 422) that may saturate the ADC. This fixed threshold may be set assuming that the PAPR (e.g., PAPR 408) and channel fading conditions (e.g., fading margin 404) are fixed. For example, the threshold may be set based on the worst-case scenarios, such as the largest possible PAPR of the input signal. However, both PAPR and fading conditions may fluctuate significantly, e.g., depending on the signal and channel profile, and using the largest possible PAPR may lead to underutilization of the ADC's full dynamic range 410 and a reduction in the efficiency of the gain control process. Table 2 shows different PAPRs for various transmission or reception scenarios. As shown in Table 2, the PAPR for a signal may vary from, for example, 4.39 dB to 13 dB depending on the waveforms and communication configurations (e.g., number of RBs).

TABLE 2
PAPRs under various transmission or reception scenarios

| | Number | | 1% PAPR | 0.1% PAPR | |
|---|---|---|---|---|---|
| Scenarios | of RBs | Tech | (dB) | (dB) | Remarks |
| NR 50M | 270 Rx, | NR | 6.88 | 8.68 | Tx Rx equal |
| Tx + Rx | 270 Rx | | | | power at ADC |
| NR 50M | 270 Tx | NR | 6.69 | 8.49 | Tx only |
| Tx | | | | | |
| NR 50M | 270 | NR | 6.7 | 8.5 | Rx only |
| Rx only | | | | | |
| NR 50M | 1 | NR | 10.6 | 13 | Rx only |
| Rx only | | | | | with 1 RB |
| LTE 20M | 100 Tx, | LTE | 6.48 | 8.18 | Tx Rx equal |
| Tx + Rx | 100 Rx | | | | power at ADC |
| LTE 20M | 100 | LTE | 4.39 | 5.69 | Tx only |
| Tx | | | | | |
| LTE 20M | 100 | LTE | 7.29 | 9.19 | Rx only |
| Rx | | | | | |
| LTE 20M | 1 | LTE | 8.49 | 10.79 | Rx only |
| Rx | | | | | with 1RB |

In some examples, the ADC's full scale power (e.g., full dynamic range 410) minus the theoretical PAPR (e.g., PAPR 408) and a fading margin (e.g., fading margin 404) may equal to the root-mean-square (RMS) input signal power (e.g., RMS power 412). The RMS input signal power corresponds to the power calculated using the RMS input signal voltage. The RMS input signal voltage can be calculated by first squaring the amplitude of the input signal at various time points within a given period. These squared values are then averaged over the time period, and the square root of this average power is taken to obtain the RMS input signal voltage. The RMS input signal power is obtained by squaring the RMS input signal voltage. In FIG. 4, the ADC backoff 414 may be determined based on the maximum possible theoretical PAPR (e.g., PAPR 408) and a fading margin (e.g., fading margin 404). The fading margin (e.g., fading margin 404) may be set to account for sudden fades in the wireless channel. However, by using fixed RSSI-based switch points (e.g., P_{GSSwitch} 420) that do not consider the real-time PAPR of the input signal, such a calculation may result in unnecessary switching of gain states (GS) and/or underutilization of the full dynamic range of the ADC.

Example aspects provide methods that use the actual measured PAPR of the input signal to determine the ADC backoff (e.g., ADC backoff 414), allowing for more precise adjustments in the ADC's power headroom. In some aspects, the entity that receives an input signal (e.g., the UE or base stations) may measure (or compute) the PAPR of the input signal, and the entity (e.g., the UE or base stations) may set the ADC backoff so that the ADC's full scale power (e.g., full dynamic range 410) minus the measured PAPR and the fading margin may equal to the RMS input signal power (or voltage). In some aspects, the measurement (or computation) of the PAPR during wireless communication, such as during an ongoing call, may allow the automatic gain control (AGC) loop of the receiver to adjust in real-time based on the downlink (DL) received signal strength indicator (RSSI) and the actual measured PAPR. For example, referring to FIG. 4, if the signal's actual PAPR (e.g., PAPR 408) is measured to be 5 dB, the ADC headroom (e.g., ADC backoff 414) may be reduced to −10 dBFS from −18 dBFS (obtained based on the largest possible PAPR), allowing for an 8 dB improvement in the ADC dynamic range for the AGC loop of the receiver.

In some examples, instead of reducing the ADC headroom (e.g., ADC backoff 414), the filtered RSSI (e.g., the RSSI filtered using a digital filter) may be backed off (e.g., reduced) by the difference (denoted as PAPR_{delta}) between the max PAPR and the current PAPR to achieve the same effect (e.g., the effect of increasing the ADC dynamic range 410). For example, the filtered RSSI may be adjusted on a per symbol basis based on the following steps. First, the difference between the maximum value of the WBEE (e.g., WBEE_{MAX}) and the average value of the WBEE (e.g., WBEE_{AVG}) may be computed to obtain the PAPR for the combination of the signal and jammer (e.g., PAPR_{Signal+jammer}) based on the formula of:

$${PAPR}_{Signal + jammer} = {WBEE}_{MAX} - {WBEE}_{AVG} \qquad ( 1 )$$

Next, the PAPR for the signal (e.g., PAPR_{Signal}) may be calculated by determining the difference between the maximum in-channel energy and the average in-channel energy according to the formula of:

$${PAPR}_{signal} = {InChannelEnergy}_{MAX} - {InChannelEnergy}_{AVG} \qquad ( 2 )$$

The in-channel energy is the energy within the channel bandwidth of the received signal. Then, the PAPR for the slot (e.g., PAPR_{Slot}) may be determined by taking the maximum value of PAPR_{Signal+jammer} and the maximum value of PAPR_{Signal} across all the valid downlink (DL) symbols according to the formula of:

$${PAPR}_{Slot} = max ( {max}_{valid DL symbols} ( {PAPR}_{Signal + jammer} ) , {max}_{valid DL symbols} ( {PAPR}_{Signal} ) ) \qquad ( 3 )$$

Assuming the maximum PAPR is X dB (e.g., PAPR_{Peak}=X dB), the difference between the maximum PAPR (e.g., PAPR_{Peak}) and the current PAPR may be computed by:

$${PAPR}_{delta} = max ( 0 , {PAPR}_{Peak} - {PAPR}_{Slot} ) = max ( 0 , X - {PAPR}_{Slot} ) \qquad ( 4 )$$

Finally, the filtered RSSI for the slot may be adjusted (e.g., reduced) according to the formula of:

$${FilteredRSSI}_{Slot} = FilterRSSI - {PAPR}_{delta} \qquad ( 5 )$$

where FilterRSSI and FilteredRSSI_{Slot} is the filtered RSSI before and after the adjustment, respectively.

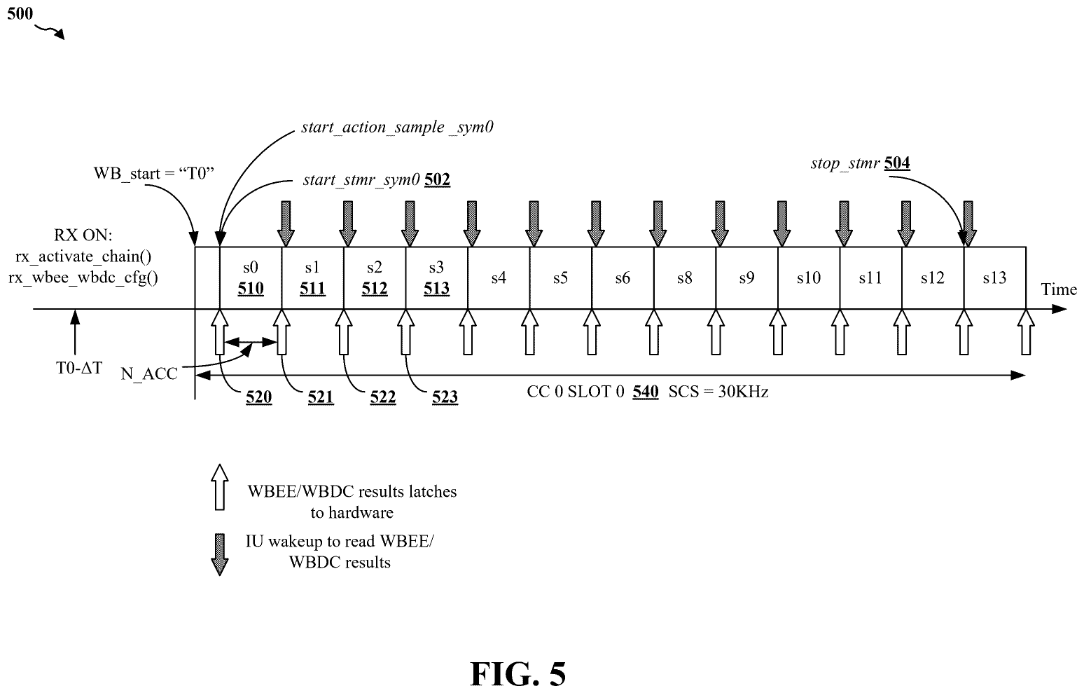

FIG. 5 is a diagram 500 illustrating example measurements of an input signal in accordance with various aspects of the present disclosure. The measurements may include the PAPR measurements and the RSSI measurements, among others. Using the PAPR measurements as an example, in FIG. 5, to measure the PAPR of an input signal, the receiver may obtain a set of power estimations of the input signal respectively corresponding to a set of time intervals within a time window, and determine the PAPR based on the set of power estimations of the input signal. For example, in FIG. 5, the firmware of the receiver may control the start time (e.g., start_stmr_sym0 502) and stop time (e.g., stop_stmr 504) of an in-phase (I) and quadrature (Q) samples (IQ samples) accumulator. Between the start time and the stop time, the receiver may retrieve (e.g., fetch) the wideband energy estimate (WBEE), which may represent the RSSI computation, and the wideband direct current (DC) estimate (WBDC), among others, for multiple IQ samples in each slot. For example, for multiple symbols (e.g., symbol s0 510, s1 511, s2 512, s3 513, etc.) in a slot (e.g., slot 0 540), the corresponding WBEE and WBDC for these symbols may be retrieved (e.g., fetched) at time occasions respectively corresponding to these symbols (e.g., time occasions 520, 521, 522, 523, etc.). The PAPR may be calculated based on these accumulated IQ samples. In some examples, the WBEE/WBDC over the symbols (e.g., 13 symbols) may be provided to the firmware on a per-receiving chain basis.

In some examples, based on the RSSI (which may be represented by WBEE, as an example), PAPR, and the current low noise amplifier (LNA) gain, the firmware may compute and output a new LNA gain. Subsequently, the firmware may program a change in the LNA gain state to align with the upcoming slot boundary. This adjustment may be provided along with the phase and DC compensation at a digital receiver chain. In some examples, the firmware may provide the timing and programming trigger information for updating the LNA, and the timing of the update may be aligned with the slot boundary, as an example.

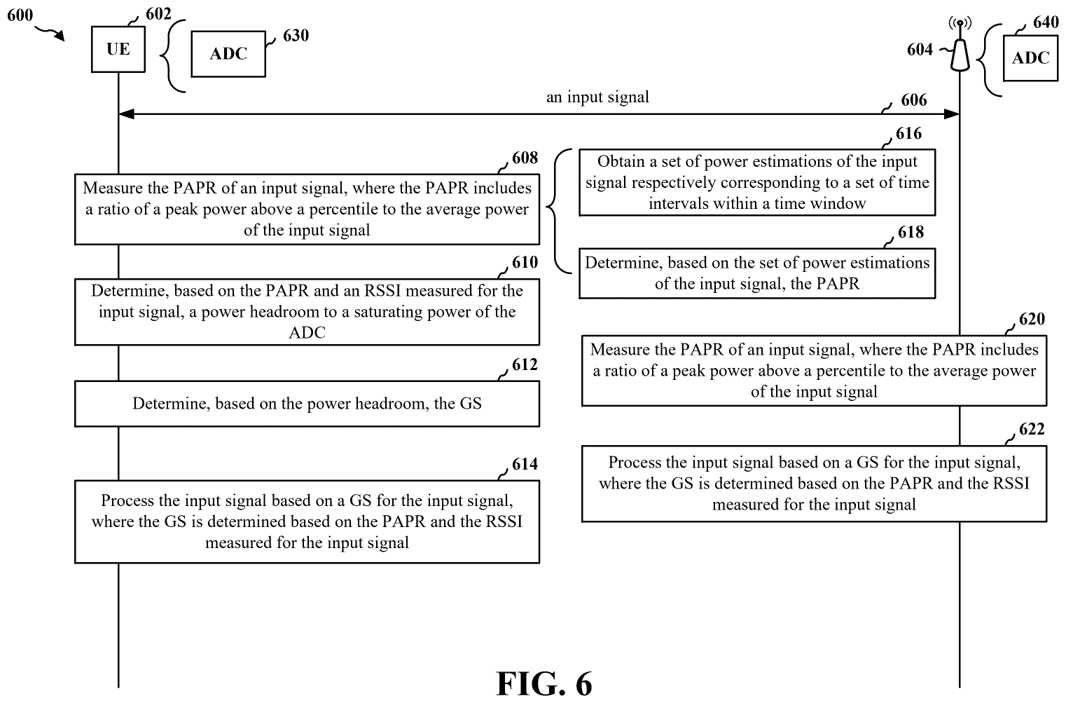

FIG. 6 is a call flow diagram 600 illustrating a method of wireless communication in accordance with various aspects of this present disclosure. Various aspects are described in connection with a UE 602 and a base station 604. The aspects may be performed by the UE 602 or the base station 604 in aggregation and/or by one or more components of a base station 604 (e.g., a CU 110, a DU 130, and/or an RU 140).

As shown in FIG. 6, at 606, a UE 602 may communicate (e.g., receive) an input signal with the base station 604. In some examples, the UE may include or be associated with an ADC 630, and the ADC 630 may perform the analog-to-digital conversion for the input signal.

At 608, the UE 602 may measure a PAPR of the input signal. The PAPR includes a ratio of the peak power above a percentile to the average power of the input signal. The percentile may be, for example, 1% percentile or 0.1% percentile. For example, for the 1% percentile, the PAPR may be the ratio of the top 1% signal power to the average power of the input signal. For the 0.1% percentile, the PAPR may be the ratio of the top 0.1% signal power to the average power of the signal. In some examples, to measure the PAPR of the input signal, the UE 602 may, at 616, obtain a set of power estimations of the input signal respectively corresponding to a set of time intervals within a time window, and, at 618, determine the PAPR based on the set of power estimations of the input signal. For example, referring to FIG. 5, the UE may obtain (e.g., fetch) WBEE and WBDC at various time occasions (e.g., time occasions 520, 521, 522, 523) for the input signal, and the PAPR of the input signal may be determined based on the WBEE/WBDC values at these time occasions.

At 610, the UE 602 may determine, based on the PAPR and an RSSI measured for the input signal, a power headroom to a saturating power of the ADC. For example, referring to FIG. 4, based on the measured PAPR (e.g., PAPR 408) and the RSSI (e.g., the WBEE obtained at 520, 521, 522, etc.), the UE may determine a power headroom (e.g., ADC backoff 414) to a saturating power (e.g., Pₘₐₓ 422) of the ADC. For example, the UE may determine the power headroom (e.g., ADC backoff 414) of the ADC 402, so that the full dynamic range 410 of the ADC 402 may be utilized. In some examples, the UE may determine the power headroom based on the RSSI according to the description in connection to Equations (1) to (4).

At 612, the UE 602 may determine, based on the power headroom, the GS of the ADC. For example, referring to FIG. 4, the UE may determine the gain switch (e.g., P_{GSSwitch} 420) to be the largest possible value while the summation of the RMS power 412 of the input signal, the measured PAPR 408, and a fading margin 404 is still less than the saturating power of the ADC (e.g., Pₘₐₓ 422). Hence, the dynamic range 410 of the ADC 402 may be fully utilized without causing the saturation of the ADC 402.

At 614, the UE 602 may process the input signal based on the GS for the input signal, where the GS is determined based on the PAPR and the RSSI measured for the input signal. For example, referring to FIG. 4, after the GS is determined on 612, the ADC 402 may perform the analog-to-digital conversion of the input signal for that particular GS.

In some examples, the methods for determining the ADC headroom and the switch points may be applicable to the ADC on the network side. For example, the base station 604 may include or be associated with an ADC 640.

In some examples, at 620, the base station 604 may measure a PAPR of an input signal. For example, the base station 604 may receive the input signal from the UE 602 at 606. The PAPR may include a ratio of a peak power above a percentile to the average power of the input signal. The percentile may be, for example, 1% percentile or 0.1% percentile. For example, for the 1% percentile, the PAPR may be the ratio of the top 1% signal power to the average power of the input signal. For the 0.1% percentile, the PAPR may be the ratio of the top 0.1% signal power to the average power of the signal. In some examples, to measure the PAPR of the input signal, the base station 604 may obtain a set of power estimations of the input signal respectively corresponding to a set of time intervals within a time window and determine the PAPR based on the set of power estimations of the input signal. For example, referring to FIG. 5, the base station may obtain (e.g., fetch) WBEE and WBDC at various time occasions (e.g., time occasions 520, 521, 522, 523) for the input signal, and the PAPR of the input signal may be determined based on the WBEE/WBDC values at these time occasions.

At 622, the base station 604 may process the input signal based on a GS for the input signal. The GS is determined based on the PAPR and RSSI measured for the input signal

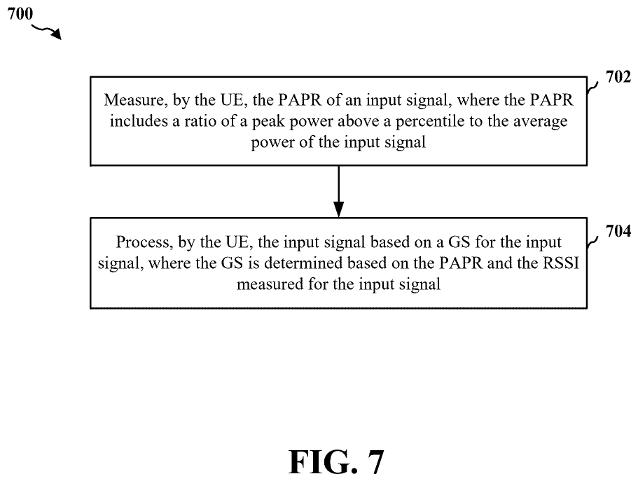

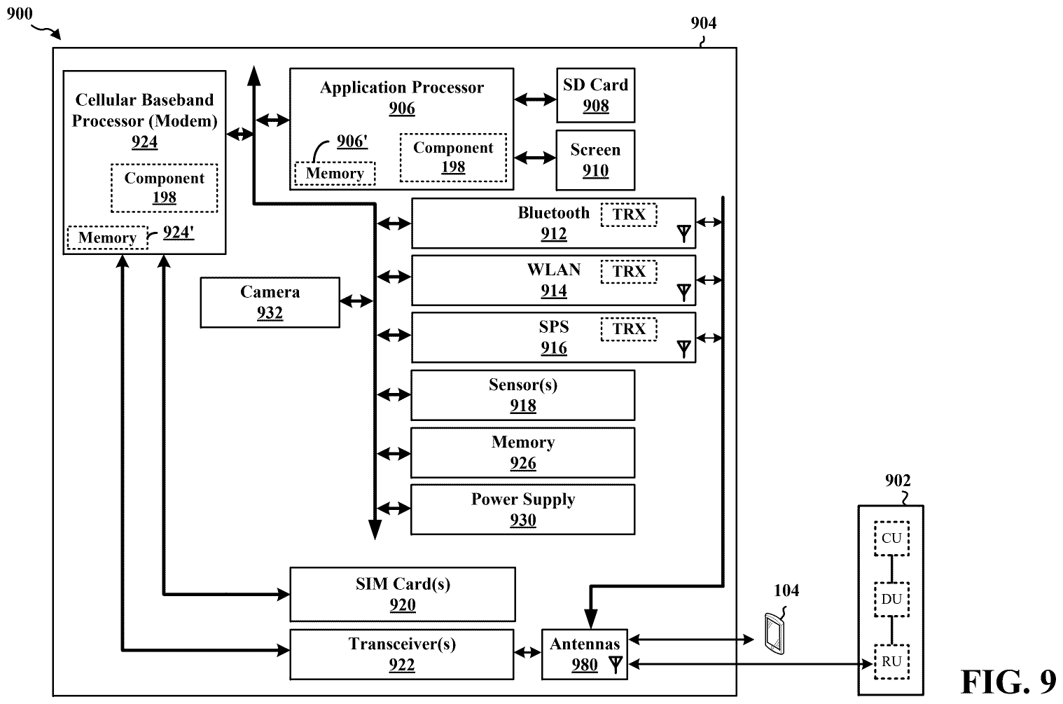

FIG. 7 is a flowchart 700 illustrating methods of wireless communication at a UE in accordance with various aspects of the present disclosure. The method may be performed by a UE. The UE may be the UE 104, 350, 602, or the apparatus 904 in the hardware implementation of FIG. 9. By dynamically adjusting the power headroom of the ADC based on actual PAPR measurements rather than a fixed margin, the methods enable more efficient use of the ADC's full dynamic range without the risk of saturation, leading to better signal fidelity and less distortion. Additionally, by enabling the ADC to use the most suitable gain state based on the actual PAPR measurements, the methods enable real-time adjustments in response to the changes in the signals, thereby allowing the signals to be represented more accurately based on the current signal conditions rather than predefined worst-case parameters.

As shown in FIG. 7, at 702, the UE may measure a PAPR of an input signal. The PAPR includes a ratio of a peak power above a percentile to the average power of the input signal. The input signal may be received from a network entity. The network entity may be a base station, or a component of a base station, in the access network of FIG. 1 or a core network component (e.g., base station 102, 310, 604; or the network entity 902 in the hardware implementation of FIG. 9). FIG. 4, FIG. 5, and FIG. 6 illustrate various aspects of the steps in connection with flowchart 700. For example, referring to FIG. 6, the UE 602 may measure, at 608, the PAPR of an input signal (e.g., an input signal received at 606). The PAPR may include a ratio of the peak power above a percentile (e.g., 1% percentile or 0.1% percentile) to the average power of the input signal. For example, referring to FIG. 5, the UE may obtain (e.g., fetch) WBEE and WBDC at various time occasions (e.g., time occasions 520, 521, 522, 523) for the input signal, and the PAPR of the input signal may be determined based on the WBEE/WBDC values at these time occasions. In some aspects, 702 may be performed by the gain control component 198.

At 704, the UE may process the input signal based on the GS for the input signal. The GS is determined based on the PAPR and the RSSI measured for the input signal. For example, referring to FIG. 6, the UE 602 may, at 614, process the input signal based on the GS for the input signal. The GS may be determined based on the PAPR and the RSSI measured for the input signal. In some aspects, 704 may be performed by the gain control component 198.

In some aspects, the gain state switch point may be based on the PAPR measured for the input signal. For example, referring to FIG. 4, the gain state switch point (e.g., P_{GSSwitch} 420) may be based on the PAPR measured for the input signal.

In some aspects, the gain state switch point may include a power threshold associated with a change of the GS for the input signal. For example, referring to FIG. 4, the gain state switch point (e.g., P_{GSSwitch} 420) may include a power threshold associated with a change of the GS for the input signal. For example, when the power of the input signal exceeds the gain state switch point (e.g., P_{GSSwitch} 420), the gain state for the input signal may be different from (e.g., lower than) the gain state of the input signal when the power of the input signal is less than the gain state switch point (e.g., P_{GSSwitch} 420).

In some aspects, the input signal may include one or more of: a downlink signal; a first combination of the downlink signal and an uplink signal, or a second combination of the downlink signal, the uplink signal, and a jammer signal. For example, referring to FIG. 6, the input signal (at 606) may include one or more of: a downlink signal; a first combination of the downlink signal and an uplink signal, or a second combination of the downlink signal, the uplink signal, and a jammer signal.

In some aspects, the GS may include a gain on an ADC on the UE, and the UE may determine, based on the PAPR and the RSSI measured for the input signal, a power headroom to a saturating power of the ADC; and determine, based on the power headroom, the GS. For example, referring to FIG. 6, the GS (at 612) may include a gain on an ADC 630 on the UE 602, and the UE 602 may, at 610, determine, based on the PAPR and the RSSI measured for the input signal, a power headroom to a saturating power of the ADC; and, at 612, determine, based on the power headroom, the GS. For example, referring to FIG. 4, based on the measured PAPR (e.g., PAPR 408) and the RSSI (e.g., the WBEE obtained at 520, 521, 522, etc.), the UE may determine a power headroom (e.g., ADC backoff 414) to a saturating power (e.g., Pₘₐₓ 422) of the ADC. For example, the UE may determine the power headroom (e.g., ADC backoff 414) of the ADC 402, so that the full dynamic range 410 of the ADC 402 may be utilized.

In some aspects, to determine the GS, the UE may select, based on the power headroom, the GS from a plurality of candidate GSs. The GS may be the largest GS of the plurality of candidate GSs that meets a power range condition. For example, referring to FIG. 6, to determine the GS (at 612), the UE 602 may select, based on the power headroom, the GS from a plurality of candidate GSs. Referring to FIG. 4, the UE may select the GS (e.g., P_{GSSwitch} 420) to be the largest possible value that meets a power range condition. For example, the power range condition may include the summation of the RMS power 412 of the input signal after applying the gain on the ADC, the measured PAPR 408, and a fading margin 404 is still less than the saturating power of the ADC (e.g., Pₘₐₓ 422). Hence, the dynamic range 410 of the ADC 402 may be fully utilized without causing the saturation of the ADC 402.

In some aspects, the RMS power of the input signal may include the average of squares of amplitudes of the input signal at a set of time points within a time period. For example, referring to FIG. 4, the RMS power 412 of the input signal may include the average of squares of amplitudes of the input signal at a set of time points within a time period.

In some aspects, to measure the PAPR of the input signal, the UE may obtain a set of power estimations of the input signal respectively corresponding to a set of time intervals within a time window; and determine, based on the set of power estimations of the input signal, the PAPR. For example, referring to FIG. 6, to measure the PAPR of the input signal at 608, the UE 602 may, at 616, obtain a set of power estimations of the input signal respectively corresponding to a set of time intervals within a time window; and, at 618, determine, based on the set of power estimations of the input signal, the PAPR. For example, referring to FIG. 5, the UE may obtain (e.g., fetch) WBEE and WBDC at various time occasions (e.g., time occasions 520, 521, 522, 523) for the input signal, and the PAPR of the input signal may be determined based on the WBEE/WBDC values at these time occasions.

In some aspects, the set of time intervals may be adjacent time intervals within the time window. For example, referring to FIG. 5, the set of time intervals (e.g., time intervals corresponding to symbols s0 510, s1 511, s2 512, etc.) may be adjacent time intervals within the time window (e.g., within the slot 0 540).

In some aspects, each time interval of the set of time intervals may be a symbol. For example, referring to FIG. 5, each time interval (e.g., time intervals corresponding to symbols s0 510, s1 511, s2 512, etc.) of the set of time intervals may be a symbol.

In some aspects, each power estimation of the set of power estimations may include one or more of the WBEE or the WBDC of the input signal in the corresponding time interval. For example, referring to FIG. 5, each power estimation of the set of power estimations may include one or more of a WBEE or a WBDC of the input signal in the corresponding time interval (e.g., time intervals corresponding to symbols s0 510, s1 511, s2 512, etc.).

In some aspects, the set of power estimations may correspond to one receiving chain of the UE. For example, referring to FIG. 5, the set of power estimations (e.g., WBEE and WBDC estimations) may be obtained on a per-receiving chain basis, and they may correspond to one receiving chain of the UE.

In some aspects, to select the GS from the plurality of candidate GSs, the UE may select the GS based on the set of power estimations, the PAPR, and an existing GS based on a fixed PAPR. For example, referring to FIG. 5, to select the GS from the plurality of candidate GSs, the UE may select the GS based on the set of power estimations (e.g., WBEE and WBDC estimations at time occasions 520, 521, 522, 523, etc.), the PAPR, and an existing GS based on a fixed PAPR.

In some aspects, to process the input signal based on the GS, the UE may apply the GS to the input signal at an application time. The application time may be aligned with a boundary of the next time window following the time window. For example, referring to FIG. 5 and FIG. 6, to process the input signal based on the GS (at 614), the UE 602 may apply the GS to the input signal at an application time. The application time may be aligned with a boundary of the next time window following the time window (e.g., the boundary of the next slot after slot 0 540).

In some aspects, the GS may include the amplification gain of an amplifier for the input signal. For example, referring to FIG. 6, the GS may include the amplification gain of an amplifier (e.g., a low noise amplifier) for the input signal.

In some aspects, to process the input signal based on the GS, the UE may apply a phase compensation and a DC compensation corresponding to the GS to the input signal at the application time. For example, referring to FIG. 5 and FIG. 6, to process the input signal based on the GS (at 614), the UE 602 may apply a phase compensation and a DC compensation corresponding to the GS to the input signal at the application time (e.g., the boundary of the next slot after slot 0 540).

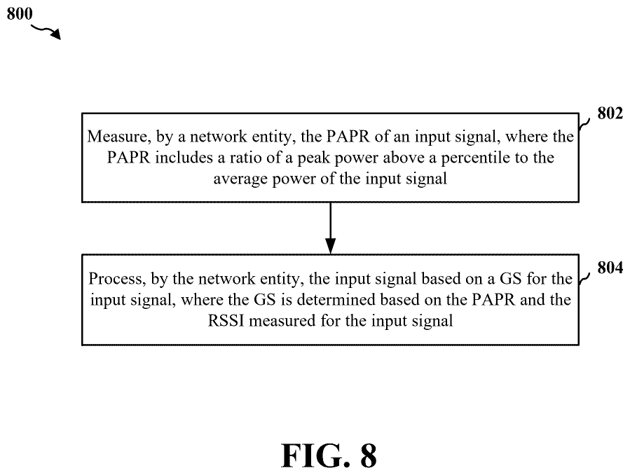

FIG. 8 is a flowchart 800 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; or the network entity 902 in the hardware implementation of FIG. 9). By dynamically adjusting the power headroom of the ADC based on actual PAPR measurements rather than a fixed margin, the methods enable more efficient use of the ADC's full dynamic range without the risk of saturation, leading to better signal fidelity and less distortion. Additionally, by enabling the ADC to use the most suitable gain state based on the actual PAPR measurements, the methods enable real-time adjustments in response to the changes in the signals, thereby allowing the signals to be represented more accurately based on the current signal conditions rather than predefined worst-case parameters.

As shown in FIG. 8, at 802, the network entity may measure a PAPR of an input signal. The PAPR may include a ratio of a peak power above a percentile to the average power of the input signal. The input signal may be received from a UE. The UE may be the UE 104, 350, 602, or the apparatus 904 in the hardware implementation of FIG. 9. FIG. 4, FIG. 5, and FIG. 6 illustrate various aspects of the steps in connection with flowchart 800. For example, referring to FIG. 6, the base station 604 may measure, at 620, the PAPR of an input signal (e.g., an input signal received at 606). The PAPR may include a ratio of the peak power above a percentile (e.g., 1% percentile or 0.1% percentile) to the average power of the input signal. For example, referring to FIG. 5, the base station may obtain (e.g., fetch) WBEE and WBDC at various time occasions (e.g., time occasions 520, 521, 522, 523) for the input signal, and the PAPR of the input signal may be determined based on the WBEE/WBDC values at these time occasions. In some aspects, 802 may be performed by the gain control component 199.

At 804, the network entity may process the input signal based on the GS for the input signal. The GS is determined based on the PAPR and the RSSI measured for the input signal. For example, referring to FIG. 6, the base station 604 may, at 622, process the input signal based on the GS for the input signal. The GS may be determined based on the PAPR and the RSSI measured for the input signal. In some aspects, 804 may be performed by the gain control component 199.

FIG. 9 is a diagram 900 illustrating an example of a hardware implementation for an apparatus 904. The apparatus 904 may be a UE, a component of a UE, or may implement UE functionality. In some aspects, the apparatus 904 may include at least one cellular baseband processor (or processing circuitry) 924 (also referred to as a modem) coupled to one or more transceivers 922 (e.g., cellular RF transceiver). The cellular baseband processor(s) (or processing circuitry) 924 may include at least one on-chip memory (or memory circuitry) 924′. In some aspects, the apparatus 904 may further include one or more subscriber identity modules (SIM) cards 920 and at least one application processor (or processing circuitry) 906 coupled to a secure digital (SD) card 908 and a screen 910. The application processor(s) (or processing circuitry) 906 may include on-chip memory (or memory circuitry) 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize the antennas 980 for communication. The cellular baseband processor(s) (or processing circuitry) 924 communicates through the transceiver(s) 922 via one or more antennas 980 with the UE 104 and/or with an RU associated with a network entity 902. The cellular baseband processor(s) (or processing circuitry) 924 and the application processor(s) (or processing circuitry) 906 may each include a computer-readable medium/memory (or memory circuitry) 924′, 906′, respectively. The additional memory modules 926 may also be considered a computer-readable medium/memory (or memory circuitry). Each computer-readable medium/memory (or memory circuitry) 924′, 906′, 926 may be non-transitory. The cellular baseband processor(s) (or processing circuitry) 924 and the application processor(s) (or processing circuitry) 906 are each responsible for general processing, including the execution of software stored on the computer-readable medium/memory (or memory circuitry). The software, when executed by the cellular baseband processor(s) (or processing circuitry) 924/application processor(s) (or processing circuitry) 906, causes the cellular baseband processor(s) (or processing circuitry) 924/application processor(s) (or processing circuitry) 906 to perform the various functions described supra. The cellular baseband processor(s) (or processing circuitry) 924 and the application processor(s) (or processing circuitry) 906 are configured to perform the various functions described supra based at least in part of the information stored in the memory (or memory circuitry). That is, the cellular baseband processor(s) (or processing circuitry) 924 and the application processor(s) (or processing circuitry) 906 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 924/application processor(s) (or processing circuitry) 906 when executing software. The cellular baseband processor(s) (or processing circuitry) 924/application processor(s) (or processing circuitry) 906 may be a component of the UE 350 and may include the at least one memory 360 and/or at least one of the TX processor 368, the RX processor 356, and the controller/processor 359. In one configuration, the apparatus 904 may be at least one processor chip (modem and/or application) and include just the cellular baseband processor(s) (or processing circuitry) 924 and/or the application processor(s) (or processing circuitry) 906, and in another configuration, the apparatus 904 may be the entire UE (e.g., see UE 350 of FIG. 3) and include the additional modules of the apparatus 904.

As discussed supra, the component 198 may be configured to measure a PAPR of an input signal, where the PAPR includes a ratio of a peak power above a percentile to the average power of the input signal; and process the input signal based on a GS for the input signal, where the GS is determined based on the PAPR and the RSSI measured for the input signal. The component 198 may be further configured to perform any of the aspects described in connection with the flowchart in FIG. 7, and/or performed by the UE 602 in FIG. 6. The component 198 may be within the cellular baseband processor(s) (or processing circuitry) 924, the application processor(s) (or processing circuitry) 906, or both the cellular baseband processor(s) (or processing circuitry) 924 and the application processor(s) (or processing circuitry) 906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 904 may include a variety of components configured for various functions. In one configuration, the apparatus 904, and in particular the cellular baseband processor(s) (or processing circuitry) 924 and/or the application processor(s) (or processing circuitry) 906, includes means for measuring a PAPR of an input signal, where the PAPR includes a ratio of a peak power above a percentile to the average power of the input signal, and means for processing the input signal based on a GS for the input signal, where the GS is determined based on the PAPR and the RSSI measured for the input signal. The apparatus 904 may further include means for performing any of the aspects described in connection with the flowchart in FIG. 7, and/or aspects performed by the UE 602 in FIG. 6. The means may be the component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

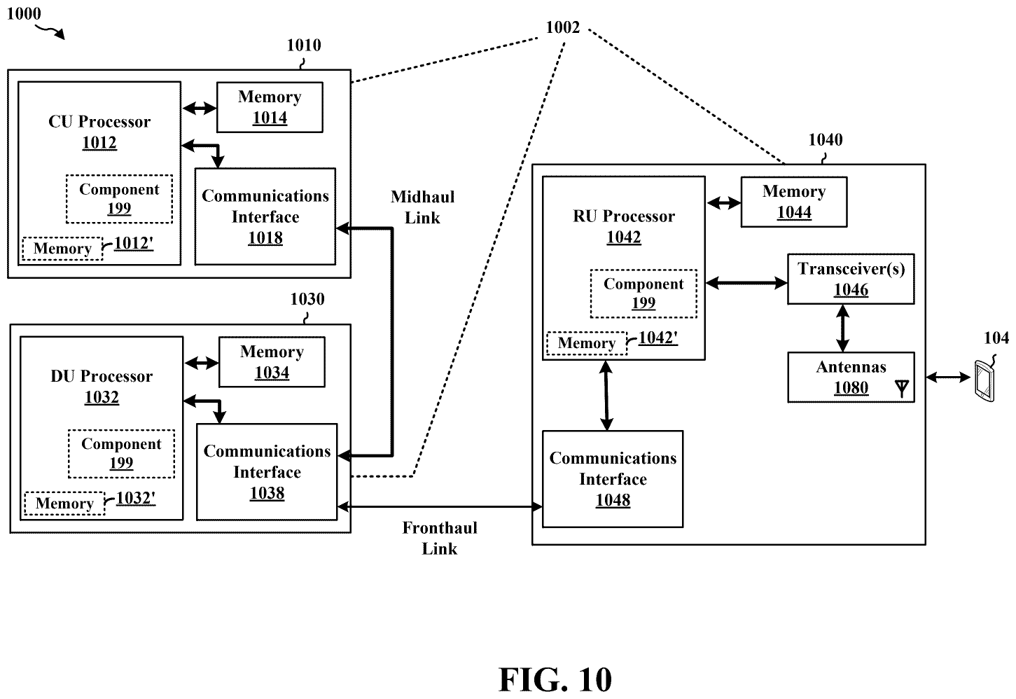

FIG. 10 is a diagram 1000 illustrating an example of a hardware implementation for a network entity 1002. The network entity 1002 may be a BS, a component of a BS, or may implement BS functionality. The network entity 1002 may include at least one of a CU 1010, a DU 1030, or an RU 1040. For example, depending on the layer functionality handled by the component 199, the network entity 1002 may include the CU 1010; both the CU 1010 and the DU 1030; each of the CU 1010, the DU 1030, and the RU 1040; the DU 1030; both the DU 1030 and the RU 1040; or the RU 1040. The CU 1010 may include at least one CU processor (or processing circuitry) 1012. The CU processor(s) (or processing circuitry) 1012 may include on-chip memory (or memory circuitry) 1012′. In some aspects, the CU 1010 may further include additional memory modules 1014 and a communications interface 1018. The CU 1010 communicates with the DU 1030 through a midhaul link, such as an F1 interface. The DU 1030 may include at least one DU processor (or processing circuitry) 1032. The DU processor(s) (or processing circuitry) 1032 may include on-chip memory (or memory circuitry) 1032′. In some aspects, the DU 1030 may further include additional memory modules 1034 and a communications interface 1038. The DU 1030 communicates with the RU 1040 through a fronthaul link. The RU 1040 may include at least one RU processor (or processing circuitry) 1042. The RU processor(s) (or processing circuitry) 1042 may include on-chip memory (or memory circuitry) 1042′. In some aspects, the RU 1040 may further include additional memory modules 1044, one or more transceivers 1046, antennas 1080, and a communications interface 1048. The RU 1040 communicates with the UE 104. The on-chip memory (or memory circuitry) 1012′, 1032′, 1042′ and the additional memory modules 1014, 1034, 1044 may each be considered a computer-readable medium/memory (or memory circuitry). Each computer-readable medium/memory (or memory circuitry) may be non-transitory. Each of the processors (or processing circuitry) 1012, 1032, 1042 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to measure a PAPR of an input signal, where the PAPR includes a ratio of a peak power above a percentile to the average power of the input signal; and process the input signal based on a GS for the input signal, where the GS is determined based on the PAPR and the RSSI measured for the input signal. The component 199 may be further configured to perform any of the aspects described in connection with the flowchart in FIG. 8, and/or performed by the base station 604 in FIG. 6. The component 199 may be within one or more processors (or processing circuitry) of one or more of the CU 1010, DU 1030, and the RU 1040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1002 may include a variety of components configured for various functions. In one configuration, the network entity 1002 includes means for measuring a PAPR of an input signal, where the PAPR includes a ratio of a peak power above a percentile to the average power of the input signal; and means for processing the input signal based on a GS for the input signal, where the GS is determined based on the PAPR and the RSSI measured for the input signal. The network entity 1002 may further include means for performing any of the aspects described in connection with the flowchart in FIG. 8, and/or aspects performed by the base station 604 in FIG. 6. The means may be the component 199 of the network entity 1002 configured to perform the functions recited by the means. As described supra, the network entity 1002 may include the TX processor 316, the RX processor 370, and the controller/processor 375. As such, in one configuration, the means may be the TX processor 316, the RX processor 370, and/or the controller/processor 375 configured to perform the functions recited by the means. This disclosure provides a method for wireless communication at a UE. The method may include measuring a PAPR of an input signal, where the PAPR includes a ratio of a peak power above a percentile to the average power of the input signal; and processing the input signal based on a GS for the input signal, where the GS is determined based on the PAPR and the RSSI measured for the input signal. By dynamically adjusting the power headroom of the ADC based on actual PAPR measurements rather than a fixed margin, the methods enable more efficient use of the ADC's full dynamic range without the risk of saturation, leading to better signal fidelity and less distortion. Additionally, by enabling the ADC to use the most suitable gain state based on the actual PAPR measurements, the methods enable real-time adjustments in response to the changes in the signals, thereby allowing the signals to be represented more accurately based on the current signal conditions rather than predefined worst-case parameters.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes measuring a peak-to-average power ratio (PAPR) of an input signal, wherein the PAPR includes a ratio of a peak power above a percentile to an average power of the input signal; and processing the input signal based on a gain state (GS) for the input signal, wherein the GS is determined based on the PAPR and a received signal strength indicator (RSSI) measured for the input signal.

Aspect 2 is the method of aspect 1, wherein a gain state switch point is based on the PAPR measured for the input signal.

Aspect 3 is the method of aspect 2, wherein the gain state switch point includes a power threshold associated with a change of the GS for the input signal.

Aspect 4 is the method of any of aspects 1 to 3, wherein the input signal includes one or more of: a downlink signal; a first combination of the downlink signal and an uplink signal, or a second combination of the downlink signal, the uplink signal, and a jammer signal.

Aspect 5 is the method of any of aspects 1 to 4, wherein the GS includes a gain on an analog-to-digital converter (ADC) on the UE, and the method further includes determining, based on the PAPR and a received signal strength indicator (RSSI) measured for the input signal, a power headroom to a saturating power of the ADC; and determining, based on the power headroom, the GS.

Aspect 6 is the method of aspect 5, wherein determining the GS includes: selecting, based on the power headroom, the GS from a plurality of candidate GSs, wherein the GS is a largest GS of the plurality of candidate GSs that meets a power range condition.

Aspect 7 is the method of aspect 6, wherein the power range condition includes a summation of a root-mean-square (RMS) power of the input signal after applying the gain on the ADC, a measured peak-to-average power based on the PAPR, and a fading margin is less than the saturating power of the ADC.

Aspect 8 is the method of aspect 7, wherein the RMS power of the input signal includes a square root of an average of squares of amplitudes of the input signal at a set of time points within a time period.

Aspect 9 is the method of aspect 6, wherein measuring the PAPR of the input signal includes obtaining a set of power estimations of the input signal respectively corresponding to a set of time intervals within a time window; and determining, based on the set of power estimations of the input signal, the PAPR.

Aspect 10 is the method of aspect 9, wherein the set of time intervals are adjacent time intervals within the time window.

Aspect 11 is the method of aspect 9, wherein each time interval of the set of time intervals is a symbol.

Aspect 12 is the method of aspect 9, wherein each power estimation of the set of power estimations includes one or more of a wideband energy estimate (WBEE) or a wideband direct current (DC) estimate (WBDC) of the input signal in the corresponding time interval.

Aspect 13 is the method of aspect 9, wherein the set of power estimations correspond to one receiving chain of the UE.

Aspect 14 is the method of aspect 9, wherein selecting the GS from the plurality of candidate GSs includes: selecting the GS based on the set of power estimations, the PAPR, and an existing GS based on a fixed PAPR.

Aspect 15 is the method of aspect 9, wherein processing the input signal based on the GS includes applying the GS to the input signal at an application time, wherein the application time is aligned with a boundary of a next time window following the time window.

Aspect 16 is the method of aspect 15, wherein the GS includes an amplification gain of an amplifier for the input signal.

Aspect 17 is the method of aspect 15, wherein processing the input signal based on the GS further includes applying to a phase compensation and a DC compensation corresponding to the GS to the input signal at the application time.

Aspect 18 is an apparatus for wireless communication at a UE, comprising: a processing system that includes processor circuitry and memory circuitry that stores code and is coupled with the processor circuitry, the processing system configured to cause the UE to perform the method of one or more of aspects 1-17.

Aspect 19 is an apparatus for wireless communication at a UE, comprising: at least one memory; and at least one processor coupled to the at least one memory and, where the at least one processor, individually or in any combination, is configured to perform the method of any of aspects 1-17.

Aspect 20 is the apparatus for wireless communication at a UE, comprising means for performing each step in the method of any of aspects 1-17.

Aspect 21 is an apparatus of any of aspects 18-20, further comprising a transceiver configured to receive or to transmit in association with the method of any of aspects 1-17.

Aspect 22 is a computer-readable medium (e.g., a non-transitory computer-readable medium) storing computer executable code at a UE, the code when executed by at least one processor causes the at least one processor to, individually or in any combination, perform the method of any of aspects 1-17.

Aspect 23 is a method of wireless communication at a network entity. The method includes measuring a peak-to-average power ratio (PAPR) of an input signal, wherein the PAPR includes a ratio of a peak power above a percentile to an average power of the input signal; and processing the input signal based on a gain state (GS) for the input signal, wherein the GS is determined based on the PAPR and the RSSI measured for the input signal.

Aspect 24 is an apparatus for wireless communication at a network entity, comprising: a processing system that includes processor circuitry and memory circuitry that stores code and is coupled with the processor circuitry, the processing system configured to cause the network entity to perform the method of aspect 23.

Aspect 25 is an apparatus for wireless communication at a network entity, comprising: at least one memory; and at least one processor coupled to the at least one memory and, where the at least one processor, individually or in any combination, is configured to perform the method of aspect 23.

Aspect 26 is the apparatus for wireless communication at a network entity, comprising means for performing each step in the method of aspect 23.

Aspect 27 is an apparatus of any of aspects 24-26, further comprising a transceiver configured to receive or to transmit in association with the method of aspect 23.

Aspect 28 is a computer-readable medium (e.g., a non-transitory computer-readable medium) storing computer executable code at a network entity, the code when executed by at least one processor causes the at least one processor to, individually or in any combination, perform the method of aspect 23.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
measure a peak-to-average power ratio (PAPR) of an input signal, wherein the PAPR includes a ratio of a peak power above a percentile to an average power of the input signal; and
process the input signal based on a gain state (GS) for the input signal, wherein the GS is determined based on the PAPR and a received signal strength indicator (RSSI) measured for the input signal.

2. The apparatus of claim 1, further comprising a transceiver coupled to the at least one processor, wherein the at least one processor, individually or in any combination, is further configured to cause the UE to communicate the input signal via the transceiver, and wherein a gain state switch point is based on the PAPR measured for the input signal.

3. The apparatus of claim 2, wherein the gain state switch point includes a power threshold associated with a change of the GS for the input signal.

4. The apparatus of claim 1, wherein the input signal includes one or more of:
a downlink signal;
a first combination of the downlink signal and an uplink signal, or
a second combination of the downlink signal, the uplink signal, and a jammer signal.

5. The apparatus of claim 1, wherein the GS includes a gain on an analog-to-digital converter (ADC) on the UE, and wherein the at least one processor, individually or in any combination, is further configured to cause the UE:
determine, based on the PAPR and the RSSI measured for the input signal, a power headroom to a saturating power of the ADC; and
determine, based on the power headroom, the GS.

6. The apparatus of claim 5, wherein to determine the GS, the at least one processor, individually or in any combination, is configured to cause the UE to:
select, based on the power headroom, the GS from a plurality of candidate GSs, wherein the GS is a largest GS of the plurality of candidate GSs that meets a power range condition.

7. The apparatus of claim 6, wherein the power range condition includes a summation of a root-mean-square (RMS) power of the input signal after applying the gain on the ADC, a measured peak-to-average power based on the PAPR, and a fading margin is less than the saturating power of the ADC.

8. The apparatus of claim 7, wherein the RMS power of the input signal includes a square root of an average of squares of amplitudes of the input signal at a set of time points within a time period.

9. The apparatus of claim 6, wherein to measure the PAPR of the input signal, the at least one processor, individually or in any combination, is configured to cause the UE to:
obtain a set of power estimations of the input signal respectively corresponding to a set of time intervals within a time window; and
determine, based on the set of power estimations of the input signal, the PAPR.

10. The apparatus of claim 9, wherein the set of time intervals are adjacent time intervals within the time window.

11. The apparatus of claim 9, wherein each time interval of the set of time intervals is a symbol.

12. The apparatus of claim 9, wherein each power estimation of the set of power estimations includes one or more of a wideband energy estimate (WBEE) or a wideband direct current (DC) estimate (WBDC) of the input signal in a corresponding time interval.

13. The apparatus of claim 9, wherein the set of power estimations correspond to one receiving chain of the UE.

14. The apparatus of claim 9, wherein to select the GS from the plurality of candidate GSs, the at least one processor, individually or in any combination, is configured to cause the UE to:
select the GS based on the set of power estimations, the PAPR, and an existing GS based on a fixed PAPR.

15. The apparatus of claim 9, wherein to process the input signal based on the GS, the at least one processor, individually or in any combination, is configured to cause the UE to:
apply the GS to the input signal at an application time, wherein the application time is aligned with a boundary of a next time window following the time window.

16. The apparatus of claim 15, wherein the GS includes an amplification gain of an amplifier for the input signal.

17. The apparatus of claim 15, wherein to process the input signal based on the GS, the at least one processor, individually or in any combination, is further configured to cause the UE to:
apply a phase compensation and a DC compensation corresponding to the GS to the input signal at the application time.

18. A method of wireless communication at a user equipment (UE), comprising:
measuring a peak-to-average power ratio (PAPR) of an input signal, wherein the peak-to-average power ratio includes a ratio of a peak power above a percentile to an average power of the input signal; and
processing the input signal based on a gain state (GS) for the input signal, wherein the GS is determined based on the PAPR and a received signal strength indicator (RSSI) measured for the input signal.

19. The method of claim 18, wherein a gain state switch point is based on the PAPR measured for the input signal.

20. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
measure a peak-to-average power ratio (PAPR) of an input signal, wherein the PAPR includes a ratio of a peak power above a percentile to an average power of the input signal; and
process the input signal based on a gain state (GS) for the input signal, wherein the GS is determined based on the PAPR and a received signal strength indicator (RSSI) measured for the input signal.
